(19) United States
(12) Patent Application Publication
(10) Pub. No.: US 2009/0213091 A1
(43) Pub. Date: Aug. 27, 2009

(54) PANEL DISPLAY WITH SELECTIVE TOUCH-ACTIVE SCREEN AREAS

(75) Inventors: Daniel Davidovici, Alpharetta, GA (US); Richard Rozalsky, Fellsmere, FL (US)

Correspondence Address: BRYAN CAVE POWELL GOLDSTEIN, ONE ATLANTIC CENTER FOURTEENTH FLOOR, 1201 WEST PEACHTREE STREET NW, ATLANTA, GA, 30309-3488, US

(73) Assignee: ADTECH-GESI, LLC, Alpharetta, GA (US)

(21) Appl. No.: 12/364,274

(22) Filed: Feb. 2, 2009

Related U.S. Application Data
(60) Provisional application No. 61/025,162, filed on Jan. 31, 2008.

(51) Int. Cl. G06F 3/045

(52) U.S. Cl. 345/174

(57) ABSTRACT

A touchscreen computer display panel apparatus having selected areas able to detect and register touch by a user and at least one selected area of higher screen resolution not being touch-activatable.

### CROSS-REFERENCE TO RELATED APPLICATION

The present application claims priority to co-pending U.S. provisional patent application No. 61/025,162, filed Jan. 31, 2008, entitled: “DIFFERENTIAL RESOLUTION TOUCHSCREEN PANEL” and commonly assigned to the assignee of the present application, the disclosure of which is incorporated herein by reference in its entirety.

### BACKGROUND

High resolution display panels are available. Touchscreen display panels are also available. The touchscreen technology, however, can use a coating on the display which degrades the quality of the displayed image. This can present a problem when the viewer needs to view a high resolution image.

### BRIEF DESCRIPTION OF THE DRAWINGS

Exemplary embodiments of the present invention are illustrated in the drawings in which like reference characters designate the same or similar parts throughout the figures of which:

FIG. 1A is a schematic view of a first exemplary embodiment of a touchscreen panel having the touch-activatable area on the left and bottom side areas of the screen.

FIG. 1B is a schematic view of a second exemplary embodiment of a touchscreen panel having the touch-activatable area on the bottom half of the screen.

FIG. 1C is a schematic view of a third exemplary embodiment of a touchscreen panel having the touch-activatable area on the upper right quadrant of the screen.

FIG. 1D is a schematic view showing an integrated panel/processor embodiment.

FIG. 2 is a schematic view of a fourth exemplary embodiment of a touchscreen panel having a resistive touch-activatable area on the bottom side of the screen and a capacitative touch area on the left side of the screen. FIG. 2 is a schematic view of an exemplary three-zone display having a high-resolution display zone and two touchscreen zones, and also shows an example wherein the touchscreen zones may use different touchscreen technologies (e.g., capacitative and resistive).

### DETAILED DESCRIPTION

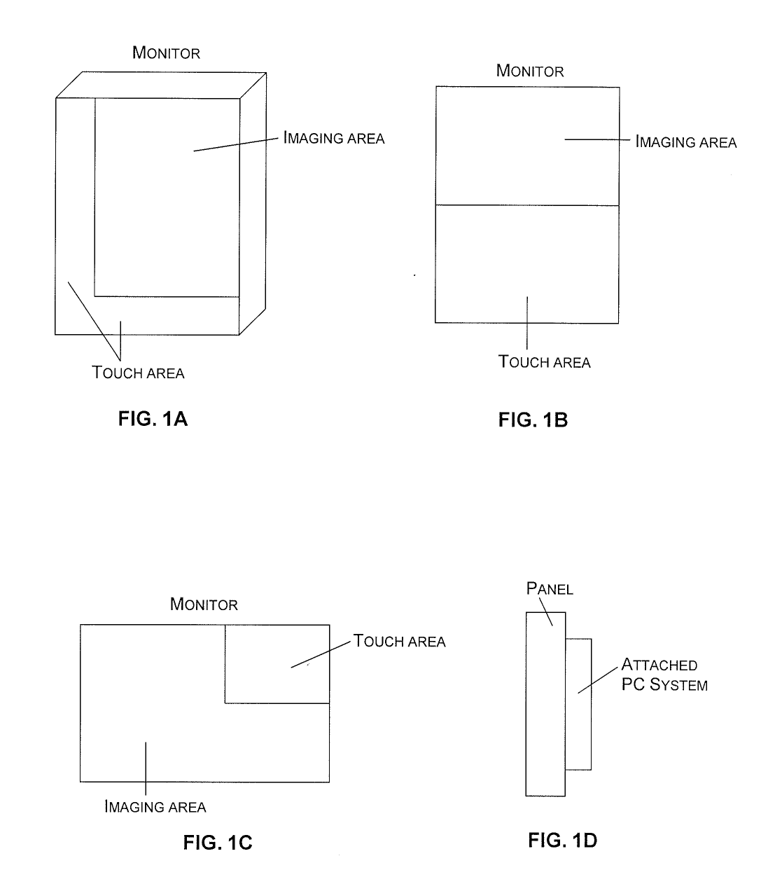

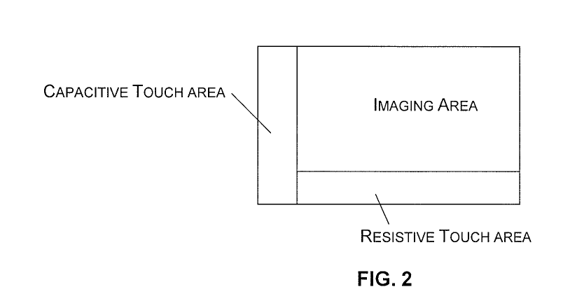

A touchscreen panel is provided which has touchscreen technology and capability in one area of the panel and high resolution capability in at least another area of the panel. The touchscreen capability is preferably on the bottom or side of the panel (see, for example, FIG. 1A) so as not to degrade the high-resolution image provided in, preferably, the main, central part of the panel. This allows the viewer to view high-resolution detail on the same display the viewer enters commands by touchscreen. One part of the display has therefore higher resolution, and the other part of the display is or may have, in effect, a lower resolution, so as to provide a differential resolution display. This could also be referred to as a split resolution display, or a split touchscreen display.

The high-resolution image and the touchscreen areas need not be placed as described above. For example, the touchscreen area could be at the four corners of the display, or could be at the top of the display, depending upon the viewing and touchscreen access requirements required for a particular use. Several exemplary arrangements of the screen are shown in FIGS. 1A-D. For example, if the viewer is sitting, the touchscreen portion could be at the bottom of the display so that the viewer's view is not blocked when the viewer is reaching for the touchscreen commands. If, however, the viewer is standing, the touchscreen portion could be at the top of the display so that the viewer could more easily reach the touchscreen commands, even if the viewer's view is temporarily or partially blocked when the viewer is reaching for the touchscreen commands.

The shape (form) and location of the touch area or areas may be placed in any desired location on the display, the only limiting factor is that the touchscreen technology area should not overlay or cover the desired high-resolution imaging area. The touchscreen ability can be provided by any desired touchscreen technology, such as, but not limited to, resistive, capacitive, or acoustic sensing techniques.

The display panel may be part of the underlying computer system, such as a display panel on a laptop computer, or an integrated panel/processor device, or may be separate from the underlying computer system, such as when used with a standalone personal computer, such as a desktop, tower, or mini-tower PC, a laptop, PDA (personal digital assistant), or the like or even a remote PC or computer system.

Also, there may be different touchscreen zones implemented by different technologies, such as capacitative, resistive, surface acoustic wave, light-sensing, or the like. For example, one touchscreen zone may use technology for sensing input by the viewer's hand, or finger, and another zone may use technology sensing input by a device, such as a pen, a light pen, a stylus, etc.

Several possible applications and uses of the touchscreen of the present disclosure are, by way of example and not by limitation, mammography display; radiology display; microscopy for operations; imaging analysis microscopy (life science, material, healthcare, physical science, and other areas); Dicom (Digital Imaging and Communications in Medicine) diagnostics; PACS (picture archiving and communication systems) systems; print media systems; and automotive, location, directional, graphics, and other applications (GPS, rendering, and the like).

FIGS. 1A-1C are block diagrams of an exemplary touchscreen locations or zones.

FIG. 1D is a block diagram of an exemplary integrated panel/processor device.

In one embodiment, the high-resolution technology is used for all, or substantially all, of the display area, and the touchscreen technology overlays or covers the area where the touchscreen technology is desired. In another embodiment, the high-resolution technology is used only for the part of the display where a high-resolution image is desired, and less-expensive, lower resolution technology is used in the part of the display where touchscreen technology is desired.

The areas of touch-sensitivity can be implemented in one embodiment as follows.

A resistive system consists of a normal glass panel that is covered with a conductive and a resistive metallic layer. These two layers are held apart by spacers, and a scratch-resistant layer is placed on top of the whole setup. An electrical current runs through the two layers while the monitor is operational. When a user touches the screen, the two layers make contact in that exact spot. The change in the electrical field is noted and the coordinates of the point of contact are calculated by the computer. Once the coordinates are known, a special driver translates the touch into something that the operating system can understand, much as a computer mouse driver translates a mouse's movements into a click or a drag.

In the capacitive system, a layer that stores electrical charge is placed on the glass panel of the monitor. When a user touches the monitor with his or her finger, some of the charge is transferred to the user, so the charge on the capacitive layer decreases. This decrease is measured in circuits located at each corner of the monitor. The computer calculates, from the relative differences in charge at each corner, exactly where the touch event took place and then relays that information to the touch-screen driver software. One advantage that the capacitive system has over the resistive system is that it transmits almost 90 percent of the light from the monitor, whereas the resistive system only transmits about 75 percent. This gives the capacitive system a much clearer picture than the resistive system.

On the monitor of a surface acoustic wave system, two transducers (one receiving and one sending) are placed along the x and y axes of the monitor's glass plate. Also placed on the glass are reflectors—they reflect an electrical signal sent from one transducer to the other. The receiving transducer is able to tell if the wave has been disturbed by a touch event at any instant, and can locate it accordingly. The wave setup has no metallic layers on the screen, allowing for 100-percent light throughput and perfect image clarity. This makes the surface acoustic wave system best for displaying detailed graphics (both other systems have significant degradation in clarity).

The front exterior of the display of the present disclosure may selectively masked to allow only a portion of the screen to be coated with a touch-activatable material or layers. For a resistive system, the coordinates corresponding to the touch-activatable areas are programmed into the processor so that only touching in the active areas will actuate a computer response.

In the capacitative system the processor can determine where the touch event took place based on the area in the layer that stores the electrical charge.

What is claimed is:

1. Any apparatus, method, product, and/or system containing or related to any component, step, and/or feature described, implied, inferred, and/or mentioned herein and/or shown in any or all of the Figures.

2. An apparatus, method, product, or system as described herein and as shown in the Figures, including each and every component, step, and feature of an embodiment.

3. A panel display apparatus, comprising:
a. a screen for presenting display information to a user and having at least one first area able to detect touch and process touch information and at least one second area not able to detect touch.
